(19) United States
(12) Patent Application Publication
(10) Pub. No.: US 2011/0075112 A1
(43) Pub. Date: Mar. 31, 2011

(54) PROJECTION DISPLAY DEVICE

(75) Inventor: Yusuke Yamamoto, Osaka-City (JP)

(73) Assignee: SANYO ELECTRIC CO., LTD., Osaka (JP)

(21) Appl. No.: 12/893,616

(22) Filed: Sep. 29, 2010

(30) Foreign Application Priority Data
Sep. 29, 2009 (JP) 2009-225601

(51) Int. Cl. G03B 21/16

(52) U.S. Cl. 353/58

(57) ABSTRACT

A projection display device includes a first exhaust fan mainly for exhausting air from a light source and a second exhaust fan mainly for exhausting air from components other than the light source. The second exhaust fan is arranged on an exhaust side of the first exhaust fan so as to overlap partly the first exhaust fan. In addition, a distance between the first exhaust fan and the second exhaust fan is set within a section in variation characteristic of a noise level of the projection display device with respect to the distance, in which the noise level does not vary even with a change in the distance.

This application claims priority under 35 U.S.C. Section 119 of Japanese Patent Application No. 2009-225601 filed Sep. 29, 2009, entitled “PROJECTION DISPLAY DEVICE”. The disclosure of the above applications is incorporated herein by reference.

### BACKGROUND OF THE INVENTION

1. Field of the Invention

The present invention relates to projection display devices that modulate light from a light source, and enlarge and project the same onto a projection plane.

2. Disclosure of Related Art

Projection display devices such as liquid crystal projectors employ a high-brightness light source such as a high-pressure mercury lamp. Such a light source may become extremely high in temperature, and therefore a high-performance exhaust system is required for exhausting heat from the light source.

For example, a projection display device may include a first exhaust fan mainly for exhausting air from a light source and a second exhaust fan mainly for exhausting air from components other than the light source. In this case, the second exhaust fan may be arranged so as to overlap partly an exhaust side of the first exhaust fan. In this arrangement, part of air exhausted from the first exhaust fan is drawn into the second exhaust fan. This facilitates discharge of air around the light source.

In the foregoing projection display device, the first exhaust fan and the second exhaust fan are arranged relatively closer to each other, which is likely to cause noise by sympathetic vibration of the two exhaust fans during operation of the device. In this case, variations in noise over time may bring a feeling of discomfort to a user.

To solve such a problem, an object of the present invention is to provide a projection display device in which, if the second exhaust fan is arranged on an exhaust side of the first exhaust fan so as to overlap partly the first exhaust fan, noise caused by the two exhaust fans is less prone to vary over time.

### SUMMARY OF THE INVENTION

A principal aspect of the present invention relates to a projection display device that modulates light from a light source and enlarges and projects the modulated light. The projection display device in this aspect includes a first exhaust fan mainly for exhausting air from the light source, and a second exhaust fan mainly for exhausting air from components other than the light source. The second exhaust fan is arranged on an exhaust side of the first exhaust fan so as to overlap partly the first exhaust fan. In addition, a distance between the first exhaust fan and the second exhaust fan is set within a section in variation characteristic of a noise level of the projection display device with respect to the distance, in which the noise level does not substantially vary even with a change in the distance.

According to the arrangement of the present invention in the principal aspect, even if there arises any change in the distance between the two exhaust fans because the first exhaust fan or the second exhaust fan comes loose during the use of the projection display device, it is possible to suppress changes in noise level due to the distance change.

### BRIEF DESCRIPTION OF THE DRAWINGS

The foregoing and other objects and novel features of the present invention will be more fully understood from the following description of a preferred embodiment when reference is made to the accompanying drawings.

FIG. 1 shows an exterior configuration of a projector in an embodiment of the present invention;

FIG. 2 shows an internal configuration of the projector in the embodiment;

FIG. 3 shows a configuration of a light source lamp and an optical system in the embodiment;

FIG. 4 is a perspective view of main components showing a structure of a first exhaust fan and a second exhaust fan attached to an exhaust opening in the embodiment;

FIG. 5 is a diagram for describing exhaust from the light source lamp and a power source section in the embodiment;

FIGS. 6A, 6B, and 6C are diagrams showing a specific positional relationship between a first intake fan and a second intake fan in the projector used for a temperature and noise test in the embodiment, and showing a positional relationship between a temperature sensor and a microphone;

FIG. 7 is a graph showing measurement results of exhaust temperature, fan temperature, and noise level, with respect to a distance between the first exhaust fan and the second exhaust fan in the embodiment;

FIG. 8 is a graph showing measurement results of exhaust temperature, fan temperature, and noise level, with respect to a distance between the first exhaust fan and the second exhaust fan in the embodiment; and

FIG. 9 is a graph showing measurement results of exhaust temperature, fan temperature, and noise level, with respect to a distance between the first exhaust fan and the second exhaust fan in the embodiment.

However, the drawings are only for purpose of description, and do not limit the scope of the present invention.

### DESCRIPTION OF PREFERRED EMBODIMENTS

A projector in an embodiment of the present invention will be described below with reference to the drawings.

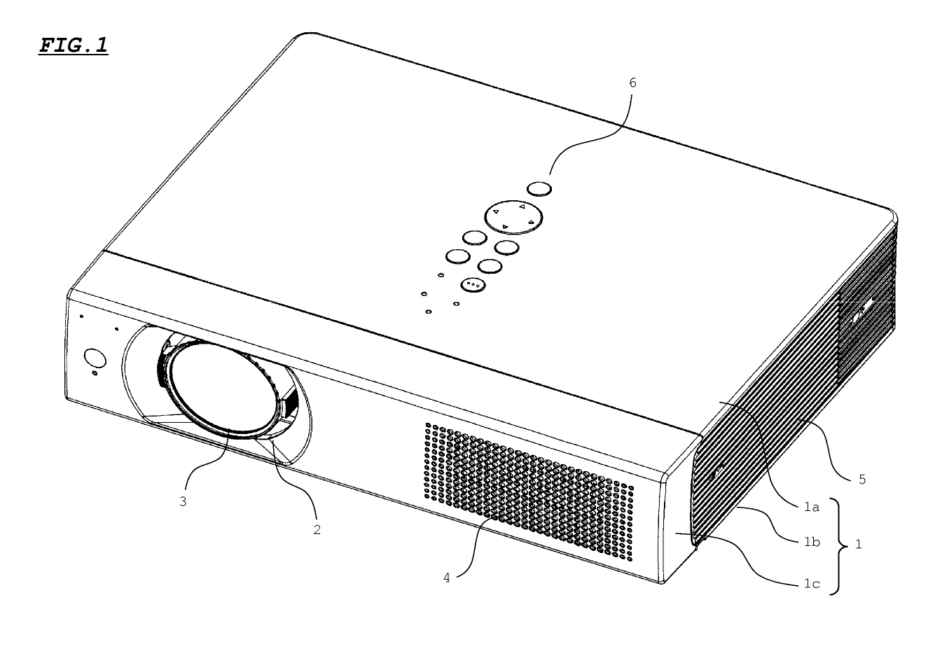

FIG. 1 is a perspective view showing an external configuration of the projector. Referring to FIG. 1, the projector includes a cabinet 1 forming an exterior thereof. The cabinet 1 is constituted by three members, that is, an upper cabinet 1a, a lower cabinet 1b, and a front cabinet 1c.

The cabinet 1 has a projection window 2 on a left side of a front surface thereof. A projection lens 3 is exposed forward at the projection window 2. The cabinet 1 has exhaust openings 4 and 5 on a right side of the front surface and on a right surface thereof. The exhaust opening 4 on the front surface has a large number of circular holes. The exhaust opening 5 has a louver structure. The cabinet 1 has an operation section 6 with a large number of operation buttons at a center of a top surface thereof.

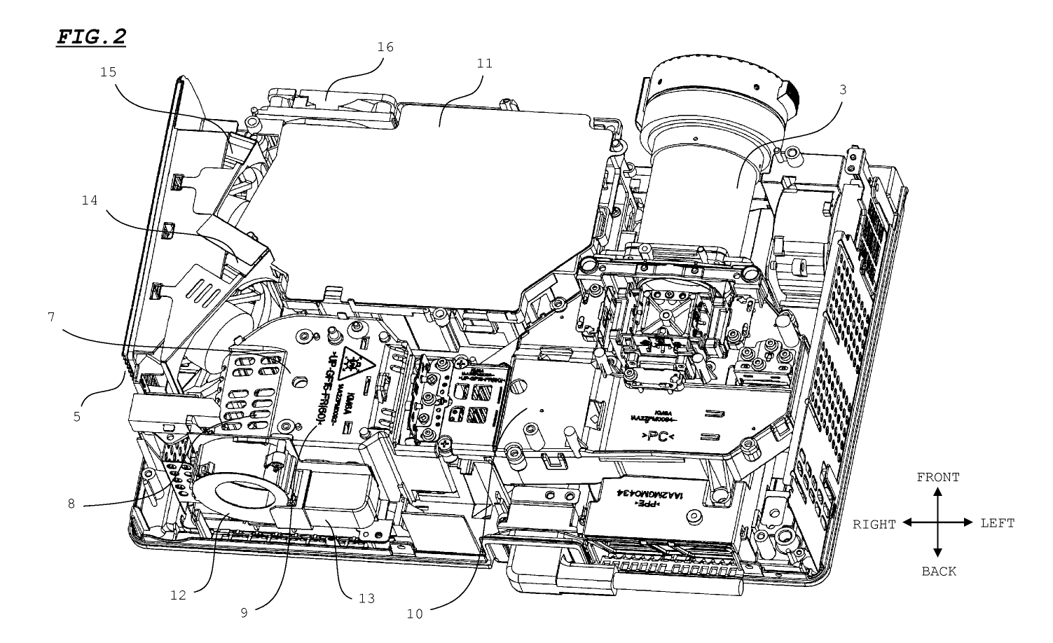

FIG. 2 is a perspective view of an internal configuration of the projector. An interior of FIG. 2 is seen by removing the upper cabinet 1a, the front cabinet 1c, and a main control circuit (not shown) from the configuration of FIG. 1.

In the interior of the cabinet 1, a light source 7 is disposed at a right back section when seen from the front side. The light source 7 includes a light source lamp 8 and a housing 9 in which the light source lamp 8 is stored. An optical system 10 is disposed in the shape of an L letter, ranging from the light source 7 to the projection lens 3.

A power source section 11 is disposed in front of the light source 7. The power source section 11 includes a power source circuit and a lamp ballast, and supplies power to various electric components of the projector such as the light source lamp 8 and liquid crystal panels.

An intake fan 12 is disposed behind the light source 7. The intake fan 12 is a centrifugal fan, for example. An intake duct 13 is interposed between the intake fan 12 and the housing 9. A first exhaust fan 14 is disposed on a right side of the light source 7, and a second exhaust fan 15 is disposed on a right side of the power source section 11. In addition, a third exhaust fan 16 is disposed in front of the power source section 11.

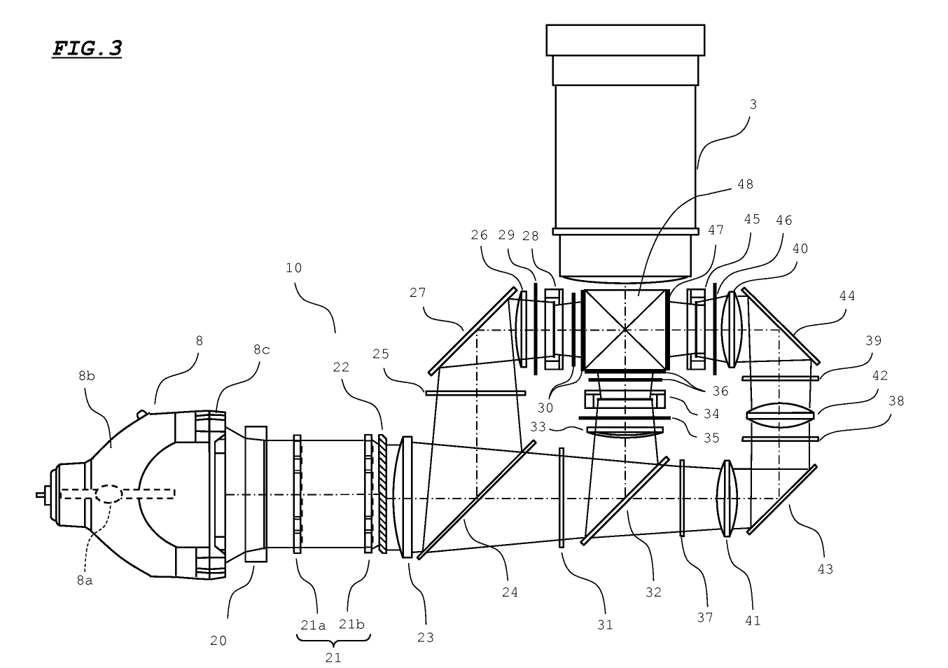

FIG. 3 is a diagram showing a configuration of the light source lamp 8 and the optical system 10.

The light source lamp 8 includes a luminous body 8a emitting white light, a reflector 8b reflecting the light emitted from the luminous body 8a, and a heat-resistant glass plate 8c covering a front opening of the reflector 8b. The luminous body 8a uses a metal halide lamp. Alternatively, the luminous body 8a may use an ultrahigh pressure mercury lamp, a xenon lamp, or the like.

White light emitted from the light source lamp 8 passes through a condenser lens 20, a fly-eye integrator 21, and a PBS array 22. The fly-eye integrator 21 includes a pair of fly-eye lenses 21a and 21b, and uniforms distribution of amounts of color lights to be irradiated to liquid crystal panels (described later). The PBS array 22 uniforms directions of polarization of light traveling toward a dichroic mirror 24 into one.

The light having passed through the PBS array 22 then passes through a condenser lens 23 and enters the dichroic mirror 24.

Out of the incident light, the dichroic mirror 24 reflects only a blue waveband light (hereinafter, referred to as “B light”), and lets a green waveband light (hereinafter, referred to as “G light”) and a red waveband light (hereinafter, referred to as “R light”) pass therethrough.

The B light reflected by the dichroic mirror 24 passes through a filter 25, and then is irradiated to a liquid crystal panel 28 for blue color in a proper irradiation state by the action of condenser lenses 23 and 26 and the reflection from a reflective mirror 27. The liquid crystal panel 28 is driven in accordance with an image signal for blue color to modulate the B light depending on a drive status. In addition, one incident-side polarizer 29 is disposed on an incident side of the liquid crystal panel 28, and therefore the B light is irradiated to the liquid crystal panel 28 through the incident-side polarizer 29. Further, two output-side polarizers 30 are disposed on an output side of the liquid crystal panel 28, and therefore the B light output from the liquid crystal panel 28 enters the output-side polarizers 30.

The G and R lights having passed through the dichroic mirror 24 then pass through a filter 31 and enter a dichroic mirror 32. The dichroic mirror 32 reflects the G light and lets the R light pass therethrough.

The G light reflected by the dichroic mirror 32 is irradiated to a liquid crystal panel 34 for green color in a proper irradiation state, by the action of the condenser lenses 23 and 33. The liquid crystal panel 34 is driven in accordance with an image signal for green color to modulate the G light depending on a drive status. In addition, one input-side polarizer 35 is disposed on an incident side of the liquid crystal panel 34, and therefore the G light is irradiated to the liquid crystal panel 34 through the incident-side polarizer 35. Further, two output-side polarizers 36 are disposed on an output side of the liquid crystal panel 34, and therefore the G light output from the liquid crystal panel 34 is irradiated to the output-side polarizers 36.

The R light having passed through the dichroic mirror 32 then passes through filters 37, 38, and 39, and then is irradiated to a liquid crystal panel 45 for red color in a proper irradiation state, by the action of the condenser lenses 23 and 40 and relay lenses 41 and 42 and by the reflection from reflective mirrors 43 and 44. The liquid crystal panel 45 is driven in accordance with an image signal for red color to modulate the R light depending on a drive status. In addition, one incident-side polarizer 46 is disposed on an incident side of the liquid crystal panel 45, and therefore the R light is irradiated to the liquid crystal panel 45 through the incident-side polarizer 46. Further, one output-side polarizer 47 is disposed on an output side of the liquid crystal panel 45, and therefore the R light output from the liquid crystal panel 45 enters the output-side polarizer 47.

The B, G, and R lights modulated by the liquid crystal panels 28, 34, and 45 enter a dichroic prism 48 through the output-side polarizers 30, 36, and 47. The dichroic prism 48 reflects the B and R lights and lets the G light pass therethrough, thereby to combine the B, G, and R lights. Accordingly, combined image light is output from the dichroic prism 48 to the projection lens 3.

Besides the transmissive liquid crystal panels 28, 34, and 45, imagers constituting the optical system 10 may use reflective liquid crystal panels or MEMS devices. In addition, the optical system 10 may not be a three-plate optical system including three imagers as described above, but may be a single-plate optical system using one imager and a color wheel, for example.

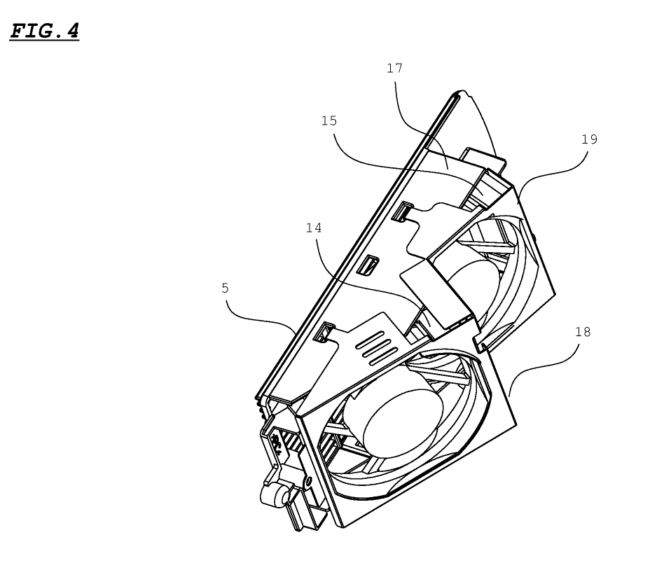

FIG. 4 is a perspective view of main components showing a structure of the first exhaust fan 14 and the second exhaust fan 15 attached to an exhaust opening 5.

A resin fan holder 17 is attached to an inside of the exhaust opening 5. The first exhaust fan 14 is attached to the fan holder 17 via a metal bracket 18. Meanwhile, the second exhaust fan 15 is attached to the fan holder 17 via a metal bracket 19. Accordingly, the second exhaust fan 15 is arranged on an exhaust side of the first exhaust fan 14 so as to overlap partly the first exhaust fan 14. The first exhaust fan 14 and the second exhaust fan 15 are both axial fans.

In addition, the first exhaust fan 14 and the second exhaust fan 15 are disposed diagonally to the exhaust opening 5. Therefore, a relatively large space is formed between the exhaust fans 14 and 15 and the exhaust opening 5.

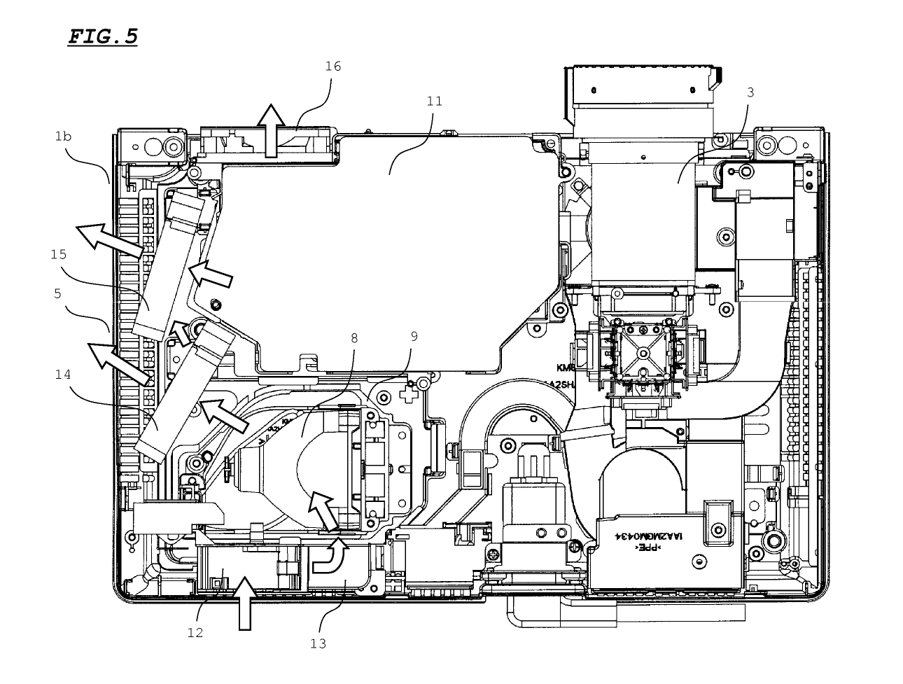

FIG. 5 is a diagram for describing exhaust from the light source lamp 8 and the power source section 11. FIG. 5 shows an internal structure of the projector. In the drawing, a top plate of the housing 9, the fan holder 17, and the brackets 18 and 19, are omitted.

When the projector is operated, the intake fan 12 and the exhaust fans 14, 15, and 16 are driven. Air taken into the intake fan 12 passes through the intake duct 13 into an interior of the housing 9 to thereby cool down an interior and exterior of the light source lamp 8.

The air having been heated to a high temperature by heat exchange with the light source lamp 8, is discharged from the housing 9 and taken into the first exhaust fan 14. In this embodiment, the second exhaust fan 15 partly overlaps the exhaust side of the first exhaust fan 14. Therefore, a portion of the air exhausted from the first exhaust fan 14 is discharged directly from the exhaust opening 5 to the outside, and another portion of the air is drawn into the second exhaust fan 15.

The air having cooled down the power source section 11 and the like is also drawn into the second exhaust fan 15 from the power source section 11 side. Accordingly, the air from the first exhaust fan 14 and the air from the power source section 11 side are mixed in the space between the second exhaust fan 15 and the intake opening 5, and then is discharged from the exhaust opening 5. Since the air from the power source section 11 side is far lower in temperature than the air from the light source 7, the high-temperature air from the light source 7 is lowered in temperature and discharged to the outside.

In addition, the air from the power source section 11 side is also discharged from the third exhaust fan 16 to the outside.

In this manner, a portion of the air from the light source 7 is drawn into the second exhaust fan 15 and is also discharged from the second exhaust fan 15 to the outside, whereby the extremely high-temperature air from the light source 7 can be dispersed and discharged powerfully into a wide area. In addition, it is possible to mix the air from the light source 7 with the air from the power source section 11 side to thereby discharge the same at a reduced temperature.

In the projection display device of this embodiment, the first exhaust fan 14 and the second exhaust fan 15 are arranged so as to overlap partly in the direction of exhaust. In addition, the first exhaust fan 14 and the second exhaust fan 15 are arranged relatively close to each other. Therefore, noise may be generated during operation due to sympathetic vibration of the two exhaust fans 14 and 15.

Accordingly, in the projector of this embodiment, considering such noise, a distance D between the first exhaust fan 14 and the second exhaust fan 15 in the direction of exhaust is set. Further, the foregoing distance D is set also in consideration of a temperature of the first exhaust fan 14 and a temperature of air exhausted from the exhaust opening 5.

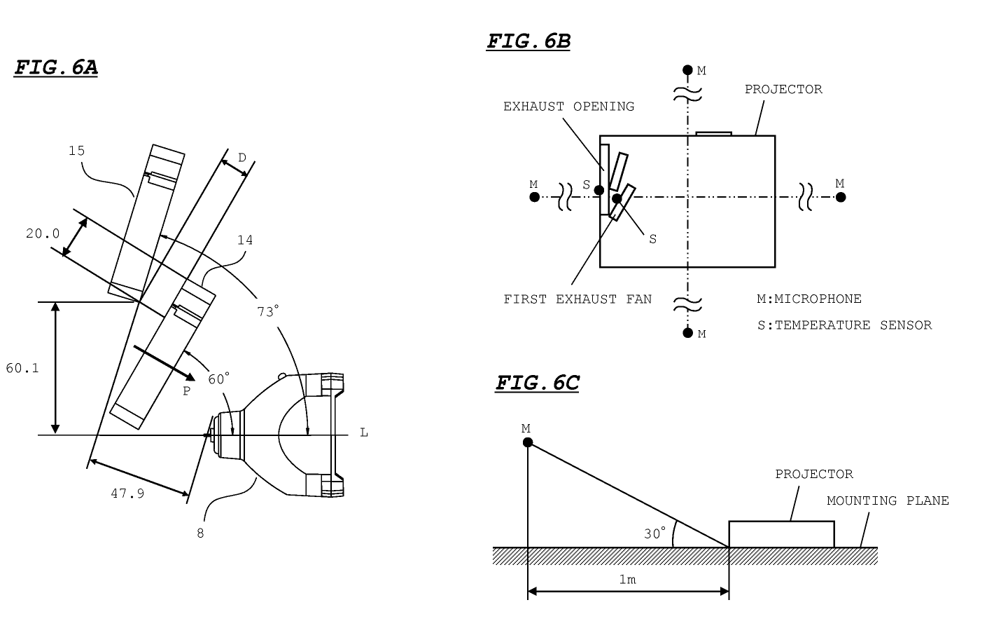

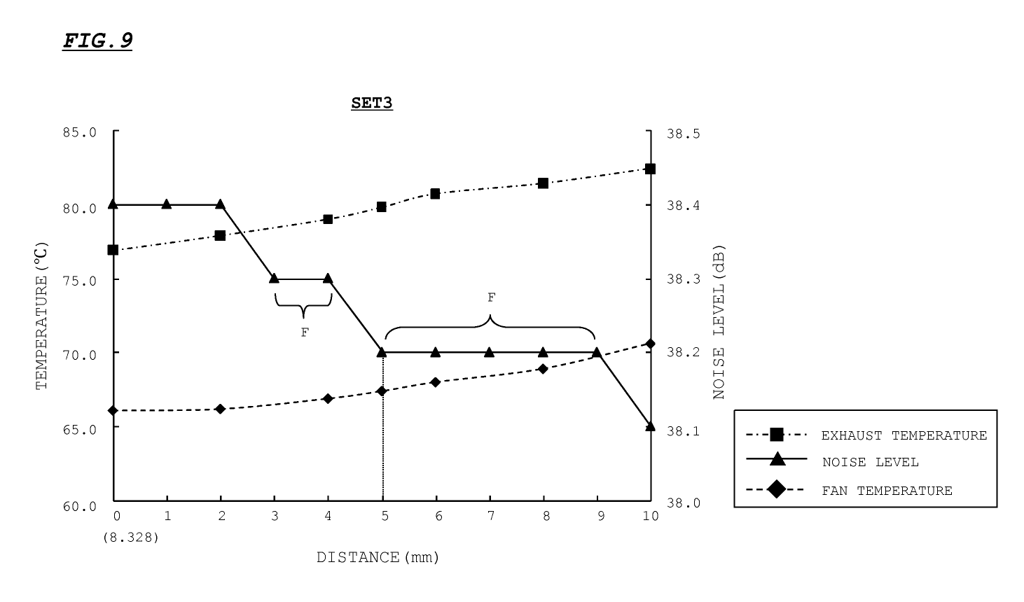

FIGS. 6A, 6B, and 6C, and FIGS. 7, 8, and 9 are diagrams for describing a temperature and noise measurement test that was conducted to set the distance D between the first exhaust fan 14 and the second exhaust fan 15. At this temperature and noise measurement test, a temperature of air exhausted from the exhaust opening 5, a temperature of the first exhaust fan (fan temperature), and a noise level from the projector, were measured with variations in the distance D between the first exhaust fan 14 and the second exhaust fan 15. In this embodiment, three projectors of the same model (set 1, set 2, and set 3) were used for the temperature and noise measurement test.

FIG. 6A is a diagram showing a specific positional relationship between the first exhaust fan 14 and the second exhaust fan 15 in each of the projectors used for the temperature and noise measurement test. FIGS. 6B and 6C are diagrams showing a positional relationship between the temperature sensor and the microphone.

In each of the projectors, a positional relationship between the second exhaust fan 15 and the light source lamp 8 is as shown in FIG. 6A. Specifically, a distance between an end surface of the second exhaust fan 15 at the intake side and the light source lamp 8 is 47.9 mm, a distance between a lower end of the second exhaust fan 15 and a light axis L of the light source lamp 8 is 60.1 mm, and an angle of inclination of the second exhaust fan 15 with respect to the light axis L is 73°. In addition, positional relationships among the first exhaust fan 14 and the second exhaust fan 15 and the light source lamp 8 are also as shown in FIG. 6A. Specifically, a width of overlap between the first exhaust fan 14 and the second exhaust fan 15 is 20.0 mm, and an angle of inclination of the first exhaust fan 14 with respect to the light axis L is 60°. The first exhaust fan 14 and the second exhaust fan 15 each have external dimensions of 70 mm high, by 70 mm wide, by 15 mm deep.

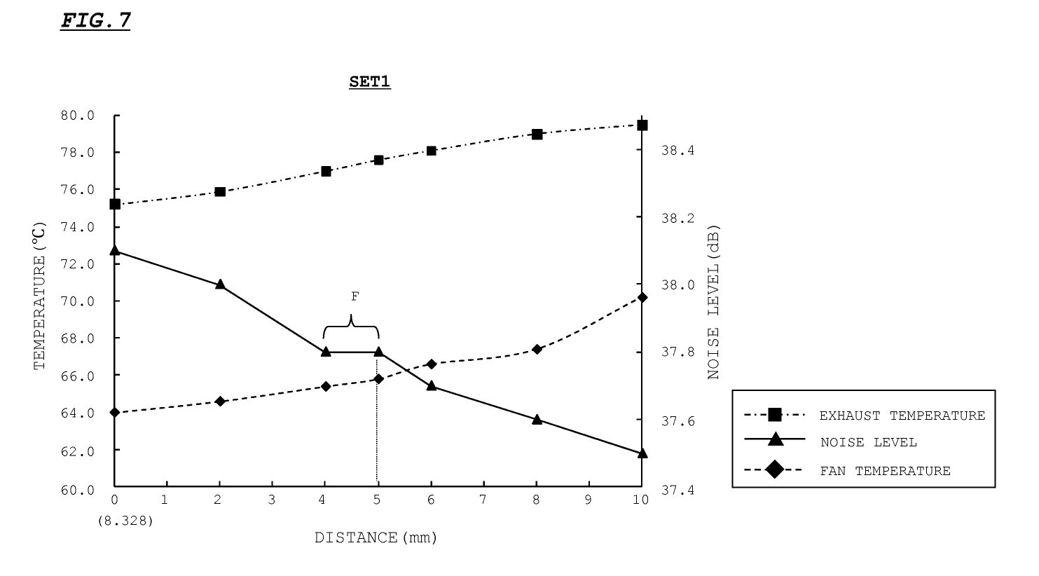

At the temperature and noise measurement test, in an installation condition shown in FIG. 6A, the first exhaust fan 14 was moved in an axial direction (a direction of arrow P in FIG. 6A) without changing the amount of overlap with the second exhaust fan 15. Then, an exhaust temperature, a fan temperature, and a noise level were measured. A distance of movement of the first exhaust fan 14 is 10 mm toward the light source lamp 8 from an initial position where the distance D is 8.328 mm. In each of graphs shown in FIGS. 7, 8, and 9 described later, numbers of 0 to 10 are assigned by 1 mm from the initial position.

Each of the projectors was operated in a normal status, and then an exhaust temperature, a fan temperature, and a noise level were measured during operation of the projector. The light source lamp 8 is a metal halide lamp that turns on with an output of 275 W during operation of the projector. The first exhaust fan 14 and the second exhaust fan 15 each have a rated voltage of 12V and a maximum air volume of 0.82 m³/min. The first exhaust fan 14 is set with an input voltage of 8.5V during operation of the projector, and the second exhaust fan 15 is set with an input voltage of 7.8V during operation of the projector.

The temperature and the noise level were separately measured. At the temperature measurement, an ambient temperature was kept at about 25° C. In addition, the noise level was measured at an anechoic chamber.

Layout of the temperature sensor and the microphone is as shown in FIGS. 6B and 6C. The exhaust temperature was measured by the temperature sensor disposed at the exhaust opening 5. The fan temperature was measured by the temperature sensor disposed at a motor part of the first exhaust fan 14. The noise level was measured by four microphones mounted on a central axis of the projector in front-back and right-left directions, at a distance of 1 m from the projector and at a position 30° above a mounting surface. The noise level was determined by averaging noise values from the four microphones and correcting the averaged value by background noise.

FIGS. 7, 8, and 9 are graphs showing measurement results of exhaust temperature, fan temperature, and noise level, with respect to the distance D between the first exhaust fan 14 and the second exhaust fan 15.

From the three graphs shown in FIGS. 7, 8, and 9, it has been found that the exhaust temperature and the fan temperature have each a variation characteristic of increasing as the first exhaust fan 14 is more distant from the second exhaust fan 15 and is closer to the light source lamp 8. This is possibly because an amount of air drawn directly from the light source lamp 8 is increased as the first exhaust fan 14 is closer to the light source lamp 8.

Meanwhile, it has also been found that the noise level has a variation characteristic of decreasing as the first exhaust fan 14 is distant from the second exhaust fan 15. This is possibly because noise resulting from sympathetic vibration of the two exhaust fans 14 and 15 decreases with an increasing distance between the two exhaust fans 14 and 15.

This temperature and noise measurement test has revealed that all the three graphs of FIGS. 7, 8, and 9 had section(s) F where there is no change or substantially no change in noise level even with varied distances (hereinafter, referred to as “flat section F”), in a variation characteristics curve of noise level. The flat section F changes in position and number among the characteristics, possibly under the influences of variations in structure and performance of components such as the exhaust fans, and variations in positional relationship among components in the assembled products, and the like.

In this embodiment, considering that the variation characteristics curve of noise level have the flat section(s) F, the distance D between the first exhaust fan 14 and the second exhaust fan 15 is set within the range of the flat section F. Accordingly, even if the distance D between the two exhaust fans 14 and 15 varies because the first exhaust fan 14 or the second exhaust fan 15 becomes loose during the use of the projector, changes in noise level due to variations in the distance D can be suppressed. Therefore, it is possible to prevent the user from feeling a discomfort due to changes in noise level.

It is ideal to determine the flat section F through measurement of a noise level for each projector and set the distance D between the first exhaust fan 14 and the second exhaust fan 15 within the flat section. In actuality, however, it is difficult from the viewpoint of production efficiency, to measure a noise level and adjust the distance D for each of projectors to be produced. Accordingly, in practice, a plurality of projectors of the same model are assessed for the characteristics of FIGS. 7, 8, and 9 to determine a tendency of noise characteristics of the model, and then the distance D for the model is set in consideration of the tendency. Needless to say, if possible, it is preferred to measure a noise level of each projector to determine the flat section F and adjust the distance D depending on the determined flat section F.

In addition, it is desired to set the distance D in consideration of an exhaust temperature and a fan temperature. Specifically, the distance D between the first exhaust fan 14 and the second exhaust fan 15 needs to be set such that the exhaust temperature is a prescribed temperature (set guarantee temperature), for example, 95° C. or less under the environment at an ambient temperature of 35° C., in relation to conformity with safety certification (UL certification). Further, the distance D needs to be set such that the fan temperature is a guarantee temperature (set guarantee temperature) or less, at which proper operation is guaranteed by a manufacturer, for example, 85° C. or less under the environment at an ambient temperature of 35° C.

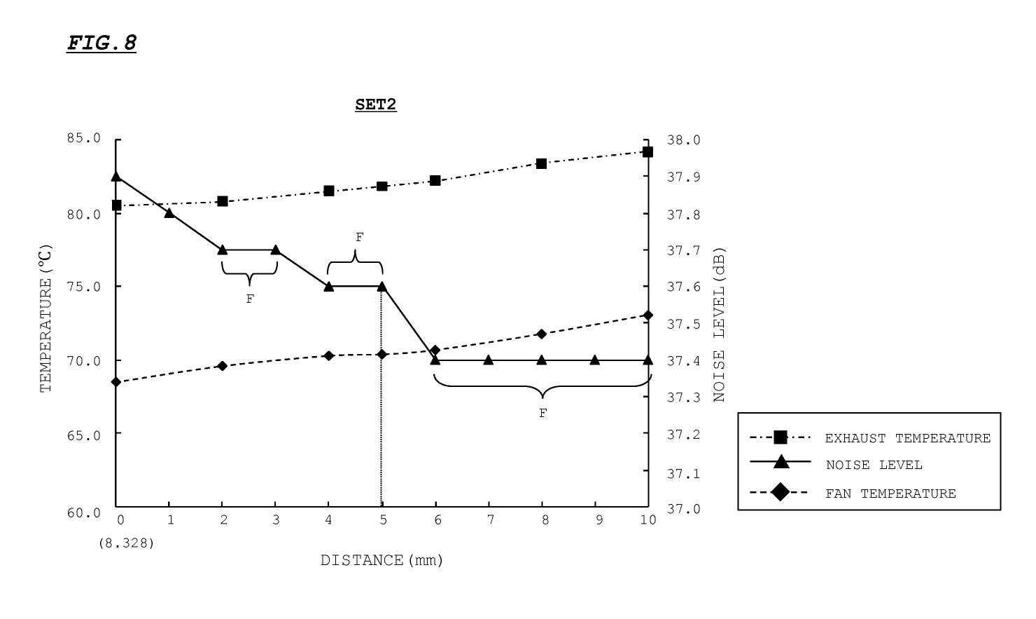

Therefore, the distance D between the first exhaust fan 14 and the second exhaust fan 15 needs to be set so as to fall within the range of the flat section F, and the exhaust temperature and the fan temperatures need to be set so as to be prescribed temperature or less and guarantee temperature or less, respectively. For example, if the projector has the characteristics of FIG. 7 or 8, when the distance D is set within the range of 12.328 to 13.328 mm, then the exhaust temperature and the fan temperature become a prescribed temperature or less and a guarantee temperature or less, respectively.

When the ambient temperature rises by 10° C., the exhaust temperature and the fan temperature also increase in almost the same manner. When the distance D is set within the range of 12.328 to 13.328 mm as described above, even if the ambient temperature kept at 25° C. rises by 10° C. and reaches 35° C. at the measurements in relation to FIGS. 7 and 8, the exhaust temperature does not exceed the prescribed temperature of 95° C. and the fan temperature does not exceed the guarantee temperature of 85° C.

As described above, when the distance D between the first exhaust fan 14 and the second exhaust fan 15 is set also in consideration of an exhaust temperature and a fan temperature, it is possible to prevent that an excessively high-temperature exhaust air is discharged from the exhaust opening 5. In addition, it is possible to prevent that the first exhaust fan 14 becomes high in temperature beyond the guarantee temperature, and thus it is possible to prevent that the first exhaust fan 14 causes trouble in exhausting operation.

Although the embodiment of the present invention is as described above, the present invention is not limited to this embodiment. In addition, the embodiment of the present invention can be appropriately modified in various manners within the scope of technical ideas recited in the claims.

What is claimed is:

1. A projection display device that modulates light from a light source and enlarges and projects the modulated light, comprising:
a first exhaust fan mainly for exhausting air from the light source; and
a second exhaust fan mainly for exhausting air from components other than the light source, wherein
the second exhaust fan is arranged on an exhaust side of the first exhaust fan so as to overlap partly the first exhaust fan, and
a distance between the first exhaust fan and the second exhaust fan is set within a section in variation characteristic of a noise level of the projection display device with respect to the distance, in which the noise level does not substantially vary even with a change in the distance.

2. The projection display device according to claim 1, comprising:
an exhaust opening on a downstream side of the first exhaust fan and the second exhaust fan, wherein
the distance between the first exhaust fan and the second exhaust fan is set such that a temperature of air exhausted from the exhaust opening does not exceed a prescribed temperature.

3. The projection display device according to claim 1, wherein
the distance between the first exhaust fan and the second exhaust fan is set such that a temperature of the first exhaust fan does not exceed a guarantee temperature therefor.
